(19) United States
(12) Patent Application Publication
(10) Pub. No.: US 2015/0234785 A1
(43) Pub. Date: Aug. 20, 2015

(54) PREDICTION APPARATUS AND METHOD FOR YIELD OF AGRICULTURAL PRODUCTS

(71) Applicant: Electronics and Telecommunications Research Institute, Daejeon (KR)

(72) Inventors: Hae Dong LEE, Daegu (KR); Ae Kyeung MOON, Daegu (KR); Soo In LEE, Daejeon (KR)

(21) Appl. No.: 14/489,424

(22) Filed: Sep. 17, 2014

(30) Foreign Application Priority Data
Feb. 14, 2014 (KR) 10-2014-0017094

(51) Int. Cl. G06F 17/18

(52) U.S. Cl. CPC G06F 17/18

(57) ABSTRACT

Provided are an apparatus and method for predicting yield of agricultural products that can accumulate information generated in all stages from before agricultural products are cultivated to when the cultivation is completed and accurately predict yield of agricultural products in the short term using the accumulated vast amount of information.

### CROSS-REFERENCE TO RELATED APPLICATION

This application claims priority to and the benefit of Korean Patent Application No. 10-2014-0017094, filed on Feb. 14, 2014, the disclosure of which is incorporated herein by reference in its entirety.

### BACKGROUND

1. Field of the Invention

The present invention relates to an apparatus and a method for predicting yield of agricultural products, and more particularly, to an apparatus and a method for accurately predicting yield of agricultural products.

2. Discussion of Related Art

The importance of agricultural outlook information has continuously increased since 1999.

Systems that support such the agricultural outlook information can merely store a research result (i.e., agricultural outlook information) or provide agricultural outlook information support service on the basis of the research result. However, the systems do not yet provide an analysis result service that utilizes the stored research result.

Information on producing areas of agricultural products that is to be utilized to understand situations such as production and transaction in the producing areas is collected by some monitoring agents (for example, employees of Korea's national agricultural cooperative federation or agricultural technology center) through a telephone survey every month.

However, the producing area information cannot be collected quickly and accurately because the monitoring agents may be often redeployed to other parts, frequently absent due to a field service for a farming area, or busy in performing tasks other than the monitoring.

Accordingly, the collected producing area information has a self-limitation when the information is utilized as basic information for understating situations such as production and transaction in places of origin of agricultural products.

Variables that affect an amount of production of agricultural products include agricultural weather data such as temperature, humidity, precipitation, sunshine, etc., agricultural damage due to a typhoon or abnormal climate, blight, price data which affects determination of a cultivation area, and distribution information about export or import of agricultural products. The sudden increase and decrease in price that are caused by instability of a supply and demand of agricultural products generated by the above variables cause great economic damage to average consumers in addition to farmers every year, repeatedly.

Accordingly, in order to prevent the above-described economic damage, an accurate short-term (less than one year) prediction for yield of agricultural products is needed.

### SUMMARY OF THE INVENTION

The present invention is directed to an apparatus and method for predicting yield of agricultural products that can accumulate information generated in all stages from before agricultural products are cultivated to when the cultivation is completed and accurately predict yield of agricultural products in the short term using the accumulated vast amount of information.

According to an aspect of the present invention, there is provided an apparatus for predicting yield of agricultural products, the apparatus including: a model design unit configured to design a monthly production amount prediction model during a growth period of an agricultural product to be predicted; and a prediction service unit configured to select any one of the monthly production amount prediction models according to variable data corresponding to a received specific cycle among variable data that affects an amount of production of the agricultural product to be predicted and to apply the variable data to the selected monthly production amount prediction model to predict the amount of production of the agricultural product to be predicted.

The model design unit may process weather information of the agricultural product to be predicted according to collected characteristic information of the agricultural product to be predicted, accumulate the processed weather information, and design a production amount prediction model for the agricultural product to be predicted using the accumulated weather information.

The model design unit may include a first weather information generation unit configured to generate first weather information of the agricultural product to be predicted using collected weather statistical data of the agricultural product to be predicted; a second weather information generation unit configured to generate second weather information of the agricultural product to be predicted according to the first weather information generated by the first weather information generation unit; and a model fitting unit configured to analyze a relation between each of the generated first weather information and second weather information and collected information of the amount of production of the agricultural product to be predicted and to design and fit a production amount prediction model for the agricultural product to be predicted according to the analyzed relation between each of the first weather information and the second weather information and the collected information of the amount of production of the agricultural product to be predicted.

The first weather information generation unit may process the weather statistical data into the first weather information including at least one of annual average temperature information, annual average sunshine information, and annual average precipitation information according to characteristic information of the agricultural product to be predicted and deliver the processed first weather information to the second weather information generation unit and the model fitting unit.

The second weather information generation unit may process the first weather information into the second weather information including at least one of information on average daily temperature range during specific months, information on a degree of precipitation during specific months, information on a degree of high temperature during specific months, and information on a degree of sunburn during specific months and deliver the processed second weather information to the model fitting unit.

The prediction service unit may include: a data storage unit configured to store the received variable data that affects the amount of production of the agricultural product to be predicted corresponding to the received specific cycle; a model selection unit configured to acquire variable data corresponding to the received specific cycle among the stored variable data from the data storage unit and select a product prediction model for the agricultural product to be predicted according to the acquired variable data and the received specific cycle; and a production amount estimation unit configured to apply the variable data acquired from the selected production amount prediction model to estimate the amount of production of the agricultural product to be predicted.

The variable data may include at least one of agricultural weather data including at least one of annual average temperature, annual average humidity, annual average precipitation, an annual average sunshine duration, and an annual average sunshine amount, data on agricultural damage due to weather, blight data, price data, and distribution information about export or import of agricultural products.

The prediction service unit may apply the variable data collected and accumulated during a whole process of cultivating the agricultural product to be predicted to the production amount prediction model selected every week or every month to predict the amount of production of the agricultural product to be predicted from an initial stage of cultivating the agricultural product to be predicted to a last stage and provide a short-term service of less than one year according to the predicted result.

According to another aspect of the present invention, there is provided a method of predicting yield of agricultural products, the method including: designing a monthly production amount prediction model during a growth period of an agricultural product to be predicted; selecting any one of the monthly production amount prediction models according to variable data corresponding to a received specific cycle among variable data that affects an amount of production of the agricultural product to be predicted; and applying the variable data to the selected monthly production amount prediction model and predicting the amount of production of the agricultural product to be predicted.

The designing of the monthly production amount prediction model may include processing weather information of the agricultural product to be predicted according to collected characteristic information of the agricultural product to be predicted to accumulate the processed weather information; and designing a production amount prediction model for the agricultural product to be predicted using the accumulated weather information.

The designing of the monthly production amount prediction model may include generating first weather information of the agricultural product to be predicted using collected weather statistical data of the agricultural product to be predicted; generating second weather information of the agricultural product to be predicted according to the first weather information; analyzing a relation between each of the generated first weather information and second weather information and collected information of the amount of production of the agricultural product to be predicted; and designing and fitting a production amount prediction model for the agricultural product to be predicted according to the analyzed relation between each of the first weather information and the second weather information and the collected information of the amount of production of the agricultural product to be predicted.

The generating of the first weather information of the agricultural product to be predicted may include processing the weather statistical data into the first weather information including at least one of annual average temperature information, annual average sunshine information, and annual average precipitation information according to characteristic information of the agricultural product to be predicted.

The generating of the second weather information of the agricultural product to be predicted may include processing the first weather information into the second weather information including at least one of information on average daily temperature range during specific months, information on a degree of precipitation during specific months, information on a degree of high temperature during specific months, and information on a degree of sunburn during specific months.

The method may further include storing the received variable data that affects the amount of production of the agricultural product to be predicted corresponding to the received specific cycle, and the selecting of any one of the monthly production amount prediction models may include: acquiring variable data corresponding to the received specific cycle among the stored variable data; and selecting a production amount prediction model for the agricultural product to be predicted according to the acquired variable data and the received specific cycle.

The variable data may include at least one of agricultural weather data including at least one of annual average temperature, annual average humidity, annual average precipitation, an annual average sunshine duration, and an annual average sunshine amount, data on agricultural damage due to weather, blight data, price data, and distribution information about export or import of agricultural products.

The predicting of the amount of production of the agricultural product to be predicted may include applying the variable data collected and accumulated during a whole process of cultivating the agricultural product to be predicted to the production amount prediction model selected every week or every month to predict the amount of production of the agricultural product to be predicted from an initial stage of cultivating the agricultural product to be predicted to a last stage; and providing a short-term service of less than one year according to the predicted result.

According to still another aspect of the present invention, there is provided an apparatus for predicting yield of agricultural products, the apparatus including: a data source unit configured to provide at least one of weather statistical data, distribution statistical data, natural disaster data, and agricultural statistical data of an agricultural product to be predicted; a model design unit configured to analyze a relation between the natural disaster data and information of the amount of production included in the agricultural statistical data and each of the weather statistical data, the distribution statistical data, and design production amount prediction models of the agricultural product to be predicted according to the analyzed relation between the information of the amount of production included in the agricultural statistical data and each of the weather statistical data, the distribution statistical data, and the natural disaster data; and a prediction service unit configured to acquire variable data corresponding to a received specific cycle among pre-stored variable data that affects the amount of production of the agricultural product to be predicted, select any one of the product prediction models according to the acquired variable data, and apply the acquired variable data to the selected production amount prediction model to provide a production amount prediction service for the agricultural product to be predicted.

The model design unit may include: a raw data collection unit configured to collect the weather statistical data, the distribution statistical data, and the natural disaster data among the data provided by the data source unit; an annual production amount collection unit configured to collect the agricultural statistical data among the data provided by the data source unit; and a model fitting unit configured to analyze a relation between weather information processed according to the data collected by the raw data collection unit and information of the amount of production of the agricultural product to be predicted that is collected by the annual production amount collection unit and design and fit a production amount prediction model for the agricultural product to be predicted according to an analyzed relation.

The prediction service unit may include: a data storage unit configured to store the collected variable data of the agricultural product to be predicted corresponding to the received specific cycle; a model selection unit configured to acquire variable data corresponding to the received specific cycle among the stored variable data from the data storage unit and select a product prediction model for the agricultural product to be predicted according to the acquired variable data and the received specific cycle; and a production amount estimation unit configured to apply the variable data acquired from the selected production amount prediction model to estimate the amount of production of the agricultural product to be predicted.

The variable data of the agricultural product to be predicted may include at least one of agricultural weather data including at least one of annual average temperature, annual average humidity, annual average precipitation, an annual average sunshine duration, and an annual average sunshine amount, data on agricultural damage due to weather, blight data, price data, and distribution information about export or import of agricultural products.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of an apparatus for predicting yield of agricultural products according to an embodiment of the present invention;

FIG. 2 is a block diagram of a prediction service unit as shown in FIG. 1; and

FIG. 3 is a flowchart showing a method of predicting yield of agricultural products according to an embodiment of the present invention.

FIG. 4 is a view illustrating a configuration of a computer device in which a method for automatically generating a visual annotation based on a visual language according to an embodiment of the present invention is executed.

### DETAILED DESCRIPTION OF EXEMPLARY EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of the example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention provides a short-term (less than one year) prediction service that is needed in each field of agriculture by combining statistics and data mining technology in an agricultural production amount field and, more particularly, provides a short-term yield prediction service from an initial stage for cultivating agricultural products to a last stage by collectively accumulating data for each cultivation process such as seeding, planting, flowering, growing, and harvest and applying the accumulated data in real-time (on a basis of week, month, and the like).

That is, the apparatus for predicting yield of agricultural products according to an embodiment of the present invention processes collected weather information into weather variables such as an annual average temperature, an annual average sunshine, and an annual average precipitation, reprocesses the processed weather variables into weather variables that most affect properties of cultivated crops such as a daily temperature range during specific months, a degree of precipitation during specific months, a degree of high temperature during specific months, a degree of sunburn during specific months and the like according to characteristic information on agricultural products to be predicted and accumulates the processed weather variables and the reprocessed weather variables.

The apparatus for predicting yield of agricultural products according to the embodiment of the present invention designs a production amount prediction model for the agricultural product to be predicted on the basis of the accumulated weather data (the processed weather variables and the reprocessed weather variables) and variables (an annual amount of production for each crop, a monthly highest temperature, a monthly lowest temperature, a monthly average temperature, a monthly average sunshine, a monthly average precipitation, a daily temperature range, change in precipitation over last month, a degree of low temperature, a degree of high temperature, a degree of sunburn, a degree of precipitation, and the like) that affect an amount of production of the agricultural product to be predicted, and provides a prediction service for the amount of production of the agricultural product to be predicted using the designed production amount prediction model.

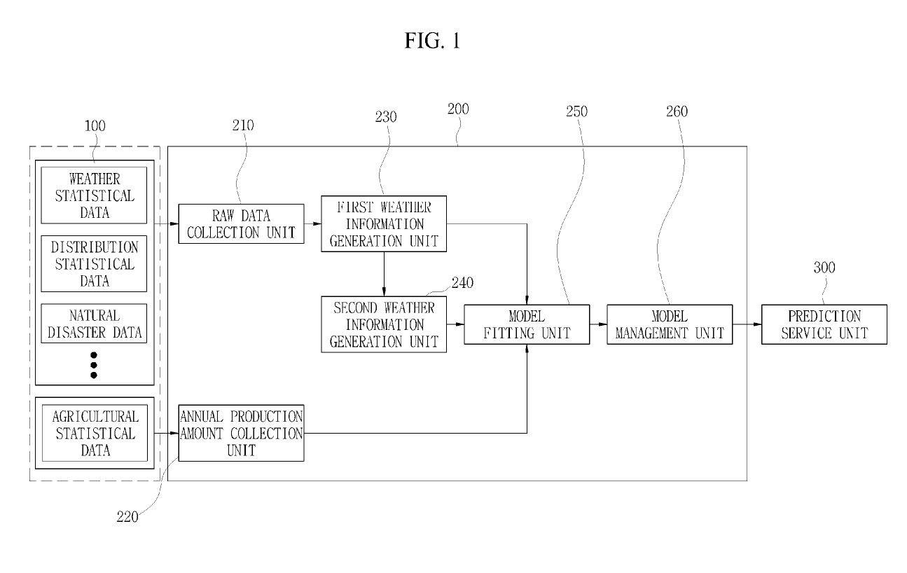

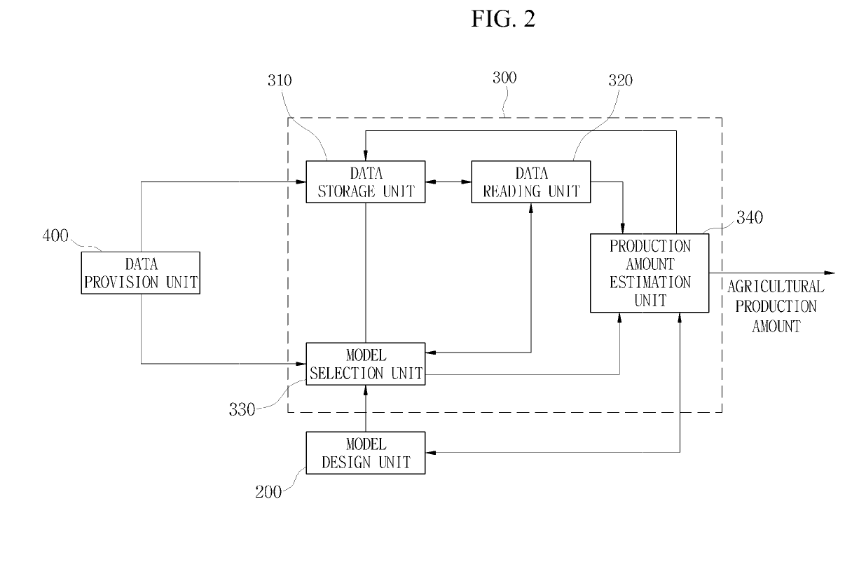

An apparatus for predicting yield of agricultural products according to the embodiment of the present invention will be described with reference to FIGS. 1 and 2. FIG. 1 is a block diagram of an apparatus for predicting yield of agricultural products according to an embodiment of the present invention.

As shown in FIG. 1, the apparatus for predicting yield of agricultural products according to the embodiment of the present invention includes a data source unit 100, a model design unit 200, and a prediction service unit 300.

The data source unit 100 provides the model design unit 200 with weather statistical data, distribution statistical data, natural disaster data, and agricultural statistical data including an amount of production, etc.

The model design unit 200 analyzes a relation between each of the weather statistical data, the distribution statistical data, the natural disaster data, and the agricultural statistical data including the amount of production, which are provided from the data source unit 100.

The model design unit 200 designs and fits a production amount prediction model for an agricultural product to be predicted according to the analyzed relation between each of the weather statistical data, the distribution statistical data, the natural disaster data, and the agricultural statistical data including the amount of production and provides the prediction service unit 300 with the fitted production amount prediction model for the agricultural product to be predicted.

The prediction service unit 300 provides a production amount prediction service (an estimated amount) for the agricultural product to be predicted for each period (every month, every other week, every week, and the like) on the basis of the production amount prediction model for the agricultural product to be predicted that is provided by the model design unit 200. That is, the prediction service unit 300 provides the prediction service (a monthly prediction result for an annual amount of production of the agricultural products) using the production amount prediction model for the agricultural product to be predicted that is provided by the model design unit 200.

A configuration of the model design unit 200 will be described below in more detail.

The model design unit 200 includes a raw data collection unit 210, an annual production amount collection unit 220, a first weather information generation unit 230, a second weather information generation unit 240, a model fitting unit 250, and a model management unit 260.

The raw data collection unit 210 collects the weather statistical data, distribution statistical data, natural disaster data, and the like that are input from the data source unit 100.

The annual production amount collection unit 220 collects the agricultural statistical data that is input from the data source unit 100 and delivers the collected agricultural statistical data to the model fitting unit 250.

The first weather information generation unit 230 generates first weather information using the weather statistical data among the data delivered from the raw data collection unit 210 and delivers the generated first weather information to the second weather information generation unit 240 and the model fitting unit 250.

For example, the first weather information generation unit 230 processes the weather statistical data into a first weather variable such as an annual average temperature, an annual average sunshine, an annual average precipitation, and the like to deliver the processed first weather variable to the second weather information generation unit 240 and the model fitting unit 250.

The second weather information generation unit 240 generates second weather information according to the first weather information delivered from the first weather information generation unit 230, and delivers the generated second weather information to the model fitting unit 250.

For example, the second weather information generation unit 240 processes the first weather variable delivered from the first weather information generation unit 230 into a second weather variable such as an average daily temperature range during specific months, a degree of precipitation during specific months, a degree of high temperature during specific months, a degree of sunburn during specific months and the like according to characteristic information on the agricultural product to be predicted and delivers the processed second weather variable to the model fitting unit 250.

The model fitting unit 250 analyzes a relation between each of the first weather information delivered from the first weather information generation unit 230 and the second weather information delivered from the second weather information generation unit 240 and information of an amount of production on the agricultural product to be predicted that is delivered from the annual production amount collection unit 220.

The model fitting unit 250 designs and fits a production amount prediction model for the agricultural product to be predicted according to the analyzed relation and delivers the fitted production amount prediction model for the agricultural product to be predicted to the model management unit 260.

The model management unit 260 manages the production amount prediction model for the agricultural product to be predicted fitted by the model fitting unit 250 and provides the fitted production amount prediction model for the agricultural product to be predicted to the prediction service unit 300.

That is, the model fitting unit 250 designs the production amount prediction model for the agricultural product to be predicted on the basis of a growing period (total months or a total cycle) of the agricultural product to be predicted, and the model management unit 260 manages the production amount prediction model for the agricultural product to be predicted designed on the basis of a growing period of the agricultural product to be predicted and provides the production amount prediction model for the agricultural product to be predicted to the prediction service unit 300.

For example, when the agricultural product to be predicted is apples, the model fitting unit 250 may design eight production amount prediction models for apples from March to October using an amount of apple production and weather information that have been accumulated for 33 years.

Next, the model management unit 260 may manage the eight production amount prediction models for apples designed by the model fitting unit 250 and provide one of the eight production amount prediction models for apples to the prediction service unit 300 upon a request of the prediction service unit 300.

An operation of the prediction service unit 300 will be described below in detail with reference to FIG. 2. FIG. 2 is a block diagram of a prediction service unit as shown in FIG. 1.

As shown in FIG. 2, the prediction service unit 300 includes a data storage unit 310, a data reading unit 320, a model selection unit 330, and a production amount estimation unit 340.

The data storage unit 310 stores a specific cycle delivered from a data provision unit 400 and agricultural product variable data corresponding to the delivered specific cycle.

For example, the data provision unit 400 delivers a specific cycle with time (season) passage and agricultural product variable data corresponding to the specific cycle to the prediction service unit 300.

Here, the agricultural variable data may affect an amount of production of the agricultural product to be predicted and include agricultural weather data such as temperature, humidity, rainfall, a duration of sunshine, an amount of sunshine, etc., agricultural damage due to a typhoon or abnormal climate, blight, price data which affects determination of a cultivation area, and distribution information about export or import of agricultural products.

In addition, the data storage unit 310 stores a collection interface that is used to collect raw data from a data collection management institution, etc.

For example, the prediction service unit 300 may be connected to the data collection management institution through the collection interface that is stored in the data storage unit 310 to collect raw data of the agricultural product to be predicted.

It has been described that the prediction service unit 300 directly collects raw data of the agricultural product to be predicted through the collection interface according to a user's manipulation, but the present invention is not limited thereto. Thus, the raw data of the data source unit 100 may be delivered through the model design unit 200 or directly from the data source unit 100.

The data reading unit 320 reads the agricultural product variable data corresponding to a request of the model selection unit 330 from the data storage unit 310 and delivers the agricultural variable data read by the data storage unit 310 to the model selection unit 330 and the production amount estimation unit 340.

When a specific cycle is delivered from the data provision unit 400, the model selection unit 330 requests, from the data reading unit 320, agricultural product variable data corresponding to the specific cycle delivered from the data provision unit 400.

The model selection unit 330 selects one of the monthly production amount prediction models designed on the basis of a growing period (total months or a total cycle) of the agricultural product to be predicted according to the specific cycle delivered from the data provision unit 400 and agricultural product variable data delivered from the data reading unit 320.

The production amount estimation unit 340 requests and provides the monthly production amount prediction model selected by the model selection unit 330 from the model design unit 200 and applies the agricultural product variable data delivered from the data reading unit 320 to the production amount prediction model provided from the model design unit 200 upon a request to estimate an amount of production of the agricultural product to be predicted.

The production amount estimation unit 340 stores the amount of production (an estimated amount) of the agricultural product to be predicted and provides the estimated amount of the production to a user such that the user may check the amount of production.

To summarize the above description, the apparatus for predicting yield of agricultural products according to the embodiment of the present invention is configured to design the production amount prediction model for the agricultural products every month (or every week) during a growing period (total months or a total cycle) of the agricultural product to be predicted, select a production amount prediction model corresponding to a month on which prediction is performed from among the designed production amount prediction models of the agricultural products, and apply agricultural product variable data accumulated to the selected production amount prediction model to estimate an monthly statistical amount of production of the agricultural products.

That is, the apparatus for predicting yield of agricultural products according to the embodiment of the present invention provides a short-term service of less than one year for yield of the agricultural products, processes collected weather information into a first weather variable and a second weather variable according to characteristic information of the agriculture product to be predicted.

Next, the apparatus for predicting yield of agricultural products according to the embodiment of the present invention use the accumulated first weather variable and second weather variable (the accumulated weather data) and real-time weather data to generate a monthly model, that is, a monthly production amount prediction model for the agricultural product to be predicted and predict annual agricultural product yield of the agricultural product to be predicted on the basis of the generated monthly production amount prediction model.

As described above, according to the embodiment of the present invention, it is possible to accumulate more data that affects the amount of production of the agricultural product to be predicted before a month during which the agricultural product is harvested comes and predict yield of the agricultural product more accurately on the basis of the accumulated data. That is, it is possible to accumulate information generated in all stages from before agricultural products are cultivated to when the cultivation is completed and thereby a vast amount of information that has been accumulated up to a prediction time when the amount of production of the agricultural product to be predicted is predicted can be utilized, thus accurately predicting yield of the agricultural products.

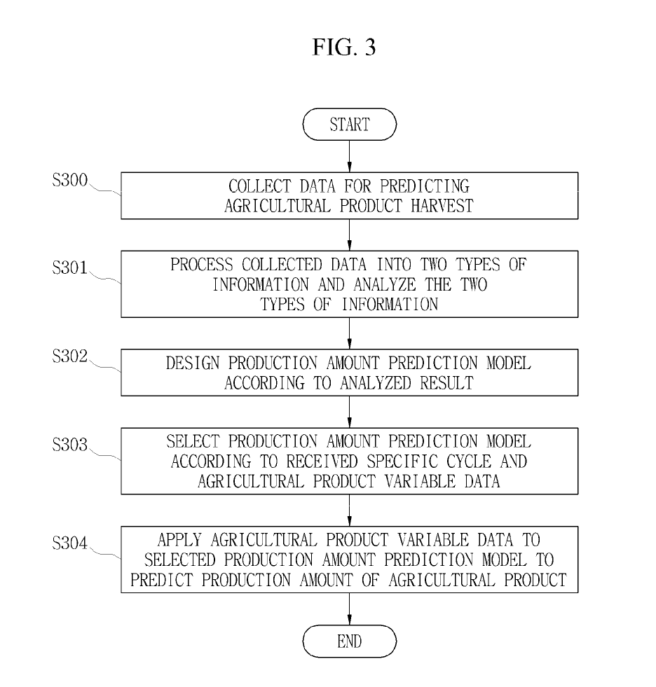

Hereinafter, a method of predicting yield of the agricultural products according to an embodiment of the present invention will be described with reference to FIG. 3. FIG. 3 is a flowchart showing the method of predicting yield of agricultural products according to the embodiment of the present invention.

As shown in FIG. 3, the method of predicting yield of agricultural products according to the embodiment of the present invention includes collecting weather statistical data, distribution statistical data, natural disaster data, and agricultural statistical data including an amount of production in operation S300.

First weather information is generated using the weather statistical data among the collected data.

For example, the weather statistical data is processed into a first weather variable such as an annual average temperature, an annual average sunshine, an annual average precipitation, and the like.

Second weather information is generated according to the first weather information.

For example, the first weather variable is processed into a second weather variable such as an average daily temperature range during specific months, a degree of precipitation during specific months, a degree of high temperature during specific months, and a degree of sunburn during specific months according to characteristic information of the agricultural product to be predicted.

The method includes analyzing a relation between each of the first weather information and the second weather information and information of the amount of production of the agricultural product to be predicted in operation S301.

The method includes designing a production amount prediction model for the agricultural product to be predicted according to the analyzed relation between each of the first weather information and the second weather information and the information of the amount of production of the agricultural product to be predicted in operation S302 and fitting and managing the designed production amount prediction model.

That is, the production amount prediction model for the agricultural product to be predicted is designed and managed on the basis of a growing period (total months or a total cycle) of the agricultural product to be predicted.

For example, when the agricultural product to be predicted is apples, eight production amount prediction models of the apples may be designed and managed from March to October using an amount of apple production and weather information that have been accumulated for 33 years.

On the other hand, a production amount prediction service (an estimated amount) for the agricultural product to be predicted for each period (every month, every other week, every week, and so on) on the basis of the fitted production amount prediction model for the agricultural product to be predicted is provided.

That is, the production amount prediction service (a monthly prediction result for an annual amount of production of the agricultural product) is provided using the fitted production amount prediction model for the agricultural product to be predicted.

For more detailed description of the above-described prediction of the amount of production of the agricultural product to be predicted, first, a specific cycle and agricultural product variable data corresponding to the specific cycle are received and then stored. For example, a specific cycle with time (seasons) passage and agricultural product variable data corresponding to the specific cycle are received and then stored.

Here, the agricultural variable data may affect the amount of production of the agricultural product to be predicted and include agricultural weather data such as temperature, humidity, rainfall, a duration of sunshine, an amount of sunshine, etc., agricultural damage due to a typhoon or abnormal climate, blight, price data which affects determination of a cultivation area, and distribution information about export or import of agricultural products.

When the specific cycle is received, agricultural product variable data corresponding to the currently received specific cycle is acquired from the stored agricultural product variable data.

The method includes selecting one of the production amount prediction models designed on the basis of a growing period (total months or a total cycle) of the agricultural product to be predicted according to the currently received specific cycle and agricultural product variable data corresponding to the currently received specific cycle in operation S303.

The method includes applying information accumulated in the selected production amount prediction model, that is, the agricultural product variable data corresponding to the currently received specific cycle, to estimate production amount of the agricultural product to be predicted in operation S304.

According to the embodiment of the present invention, it is possible to accumulate a vast amount of information generated in all stages from before agricultural products are cultivated to when the cultivation is completed and accurately predict yield of agricultural products in the short term using the accumulated vast amount of information.

The estimated production amount (an estimated amount) of the agricultural product to be predicted is stored and then provided such that the user may check the amount of production.

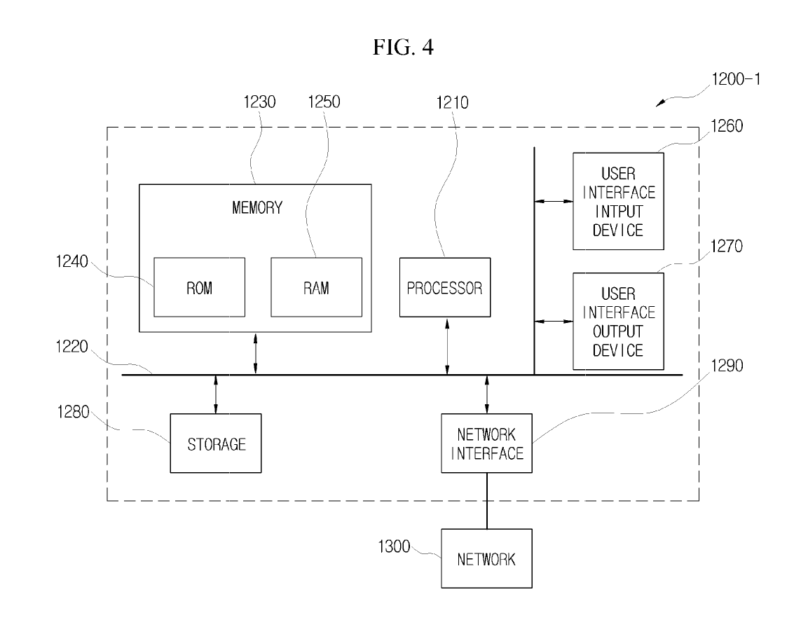

A method for automatically generating a visual annotation based on a visual language according to an embodiment of the present invention may be implemented in a computer system, e.g., as a computer readable medium. As shown in in FIG. 4, a computer system 1200-1 may include one or more of a processor 1210, a memory 1230, a user input device 1260, a user output device 1270, and a storage 1280, each of which communicates through a bus 1220. The computer system 1200-1 may also include a network interface 1290 that is coupled to a network 1300. The processor 1210 may be a central processing unit (CPU) or a semiconductor device that executes processing instructions stored in the memory 1230 and/or the storage 1280. The memory 1230 and the storage 1280 may include various forms of volatile or non-volatile storage media. For example, the memory may include a read-only memory (ROM) 1240 and a random access memory (RAM) 1250.

Accordingly, a method for automatically generating a visual annotation based on a visual language according to an embodiment of the present invention may be implemented as a computer implemented method or as a non-transitory computer readable medium with computer executable instructions stored thereon. In an embodiment, when executed by the processor, the computer readable instructions may perform a method according to at least one aspect of the invention.

It should be understood that although the present invention has been described above in detail with reference to the accompanying drawings and exemplary embodiments, this is illustrative only and various modifications may be made without departing from the spirit or scope of the invention. Thus, the scope of the present invention is to be determined by the following claims and their equivalents, and shall not be restricted or limited by the foregoing detailed description.

What is claimed is:

1. An apparatus for predicting yield of agricultural products, the apparatus comprising:
a model design unit configured to design a monthly production amount prediction model during a growth period of an agricultural product to be predicted; and
a prediction service unit configured to select any one of the monthly production amount prediction models according to variable data corresponding to a received specific cycle among variable data that affects an amount of production of the agricultural product to be predicted and to apply the variable data to the selected monthly production amount prediction model to predict the amount of production of the agricultural product to be predicted.

2. The apparatus of claim 1, wherein the model design unit processes weather information of the agricultural product to be predicted according to collected characteristic information of the agricultural product to be predicted, accumulates the processed weather information, and designs a production amount prediction model for the agricultural product to be predicted using the accumulated weather information.

3. The apparatus of claim 1, wherein the model design unit comprises:
a first weather information generation unit configured to generate first weather information of the agricultural product to be predicted using collected weather statistical data of the agricultural product to be predicted;
a second weather information generation unit configured to generate second weather information of the agricultural product to be predicted according to the first weather information generated by the first weather information generation unit; and
a model fitting unit configured to analyze a relation between each of the generated first weather information and second weather information and collected information of the amount of production of the agricultural product to be predicted and to design and fit a production amount prediction model for the agricultural product to be predicted according to the analyzed relation between each of the first weather information and the second weather information and the collected information of the amount of production of the agricultural product to be predicted.

4. The apparatus of claim 3, wherein the first weather information generation unit processes the weather statistical data into the first weather information including at least one of annual average temperature information, annual average sunshine information, and annual average precipitation information according to characteristic information of the agricultural product to be predicted and delivers the processed first weather information to the second weather information generation unit and the model fitting unit.

5. The apparatus of claim 3, wherein the second weather information generation unit processes the first weather information into the second weather information including at least one of information on average daily temperature range during specific months, information on a degree of precipitation during specific months, information on a degree of high temperature during specific months, and information on a degree of sunburn during specific months, and delivers the processed second weather information to the model fitting unit.

6. The apparatus of claim 1, wherein the prediction service unit comprises:
a data storage unit configured to store the received variable data that affects the amount of production of the agricultural product to be predicted corresponding to the received specific cycle;
a model selection unit configured to acquire variable data corresponding to the received specific cycle among the stored variable data from the data storage unit and select a product prediction model for the agricultural product to be predicted according to the acquired variable data and the received specific cycle; and
a production amount estimation unit configured to apply the variable data acquired from the selected production amount prediction model to estimate the amount of production of the agricultural product to be predicted.

7. The apparatus of claim 1, wherein the variable data includes at least one of agricultural weather data including at least one of annual average temperature, annual average humidity, annual average precipitation, an annual average sunshine duration, and an annual average sunshine amount, data on agricultural damage due to weather, blight data, price data, and distribution information about export or import of agricultural products.

8. The apparatus of claim 1, wherein the prediction service unit applies the variable data collected and accumulated during a whole process of cultivating the agricultural product to be predicted to the production amount prediction model selected every week or every month to predict the amount of production of the agricultural product to be predicted from an initial stage of cultivating the agricultural product to be predicted to a last stage and provides a short-term service of less than one year according to the predicted result.

9. A method of predicting yield of agricultural products, the method comprising:
designing a monthly production amount prediction model during a growth period of an agricultural product to be predicted;
selecting any one of the monthly production amount prediction models according to variable data corresponding to a received specific cycle among variable data that affects an amount of production of the agricultural product to be predicted; and
applying the variable data to the selected monthly production amount prediction model and predicting the amount of production of the agricultural product to be predicted.

10. The method of claim 9, wherein the designing of the monthly production amount prediction model comprises:
processing weather information of the agricultural product to be predicted according to collected characteristic information of the agricultural product to be predicted to accumulate the processed weather information; and
designing a production amount prediction model for the agricultural product to be predicted using the accumulated weather information.

11. The method of claim 9, wherein the designing of the monthly production amount prediction model comprises:
generating first weather information of the agricultural product to be predicted using collected weather statistical data of the agricultural product to be predicted;
generating second weather information of the agricultural product to be predicted according to the first weather information;
analyzing a relation between each of the generated first weather information and second weather information and collected information of the amount of production of the agricultural product to be predicted; and
designing and fitting a production amount prediction model for the agricultural product to be predicted according to the analyzed relation between each of the first weather information and the second weather information and the collected information of the amount of production of the agricultural product to be predicted.

12. The method of claim 11, wherein the generating of the first weather information of the agricultural product to be predicted comprises processing the weather statistical data into the first weather information including at least one of annual average temperature information, annual average sunshine information, and annual average precipitation information according to characteristic information of the agricultural product to be predicted.

13. The method of claim 11, wherein the generating of the second weather information of the agricultural product to be predicted comprises processing the first weather information into the second weather information including at least one of information on average daily temperature range during specific months, information on a degree of precipitation during specific months, information on a degree of high temperature during specific months, and information on a degree of sunburn during specific months.

14. The method of claim 9, further comprising storing the received variable data that affects the amount of production of the agricultural product to be predicted corresponding to the received specific cycle,
wherein the selecting of any one of the monthly production amount prediction models comprises:
acquiring variable data corresponding to the received specific cycle among the stored variable data; and
selecting a production amount prediction model for the agricultural product to be predicted according to the acquired variable data and the received specific cycle.

15. The method of claim 9, wherein the variable data includes at least one of agricultural weather data including at least one of annual average temperature, annual average humidity, annual average precipitation, an annual average sunshine duration, and an annual average sunshine amount, data on agricultural damage due to weather, blight data, price data, and distribution information about export or import of agricultural products.

16. The method of claim 9, wherein the predicting of the amount of production of the agricultural product to be predicted comprises:
applying the variable data collected and accumulated during a whole process of cultivating the agricultural product to be predicted to the production amount prediction model selected every week or every month to predict the amount of production of the agricultural product to be predicted from an initial stage of cultivating the agricultural product to be predicted to a last stage; and
providing a short-term service of less than one year according to the predicted result.

17. An apparatus for predicting yield of agricultural products, the apparatus comprising:
a data source unit configured to provide at least one of weather statistical data, distribution statistical data, natural disaster data, and agricultural statistical data of an agricultural product to be predicted;
a model design unit configured to analyze a relation between the natural disaster data and information of an amount of production included in the agricultural statistical data and each of the weather statistical data, the distribution statistical data, and design production amount prediction models of the agricultural product to be predicted according to the analyzed relation between the information of the amount of production included in the agricultural statistical data and each of the weather statistical data, the distribution statistical data, and the natural disaster data; and
a prediction service unit configured to acquire variable data corresponding to a received specific cycle among pre-stored variable data that affects the amount of production of the agricultural product to be predicted, select any one of the production amount prediction models according to the acquired variable data, and apply the acquired variable data to the selected production amount prediction model to provide a production amount prediction service for the agricultural product to be predicted.

18. The apparatus of claim 17, wherein the model design unit comprises:
a raw data collection unit configured to collect the weather statistical data, the distribution statistical data, and the natural disaster data among the data provided by the data source unit;
an annual production amount collection unit configured to collect the agricultural statistical data among the data provided by the data source unit; and
a model fitting unit configured to analyze a relation between weather information processed according to the data collected by the raw data collection unit and information of the amount of production of the agricultural product to be predicted that is collected by the annual production amount collection unit and design and fit a production amount prediction model for the agricultural product to be predicted according to an analyzed relation.

19. The apparatus of claim 17, wherein the prediction service unit comprises:
a data storage unit configured to store the collected variable data of the agricultural product to be predicted corresponding to the received specific cycle;
a model selection unit configured to acquire variable data corresponding to the received specific cycle among the stored variable data from the data storage unit and select a production amount prediction model for the agricultural product to be predicted according to the acquired variable data and the received specific cycle; and
a production amount estimation unit configured to apply the variable data acquired from the selected production amount prediction model to estimate the amount of production of the agricultural product to be predicted.

20. The apparatus of claim 17, wherein the variable data of the agricultural product to be predicted includes at least one of agricultural weather data including at least one of annual average temperature, annual average humidity, annual average precipitation, an annual average sunshine duration, and an annual average sunshine amount, data on agricultural damage due to weather, blight data, price data, and distribution information about export or import of agricultural products.
